(19) United States
(12) Patent Application Publication
(10) Pub. No.: US 2003/0027544 A1
(43) Pub. Date: Feb. 6, 2003

(54) Remote radio receiver

(76) Inventors: David H. Donovan, San Diego, CA (US); Betsy C. Huntingdon, San Diego, CA (US); Christopher G. Wykoff, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/921,229

(22) Filed: Aug. 1, 2001

(51) Int. Cl. H04B 1/06

(52) U.S. Cl. 455/344; 455/66

(57) ABSTRACT

A remote radio receiver includes audio circuitry, a user selection interface, user control circuitry and input/output interface. The audio circuitry is for receiving a digital audio stream and playing extracted audio signals over a speaker. The user control circuitry generates control signals as a result of a user interacting with the user selection interface. The input/output interface provides connection to a remote computer. The input/output interface forwards the digital audio stream from the remote computer to the audio circuitry. The input/output interface forwards the control signals from the user control circuitry to the remote computer.

### BACKGROUND OF THE INVENTION

It is currently possible to access many radio stations by a personal computer via the internet. Audio information is streamed to a personal computer that can then play the information via internal or external speakers.

Unfortunately, most personal computers include one or more fans which are noisy. This can interfere with the listening pleasure of the user. Many personal computers also have low quality sound reproduction. In addition, personal computers when connected to the internet via traditional modem, digital subscriber line (DSL) or cable modem are not portable. Thus a user listening to a radio station via the internet may be limited in the locations where the radio station can be enjoyed.

### SUMMARY OF THE INVENTION

In accordance with the preferred embodiment of the present invention, a remote radio receiver is presented. The remote radio receiver includes audio circuitry, a user selection interface, user control circuitry and input/output interface. The audio circuitry is for receiving a digital audio stream and playing extracted audio signals over a speaker. The user control circuitry generates control signals as a result of a user interacting with the user selection interface. The input/output interface provides connection to a remote computer. The input/output interface forwards the digital audio stream from the remote computer to the audio circuitry. The input/output interface forwards the control signals from the user control circuitry to the remote computer.

### BRIEF DESCRIPTION OF THE DRAWINGS

FIG. 1 is a simplified diagram showing a personal computer connected to a remote internet radio receiver in accordance with a preferred embodiment of the present invention.

FIG. 2 is a simplified block diagram of a remote internet radio receiver in accordance with a preferred embodiment of the present invention.

FIG. 3 is a simplified flowchart illustrating operation of processor within a remote internet radio receiver in accordance with a preferred embodiment of the present invention.

FIG. 4 is a simplified block diagram of a remote internet radio receiver in accordance with an alternative preferred embodiment of the present invention.

### DETAILED DESCRIPTION OF THE PREFERRED EMBODIMENT

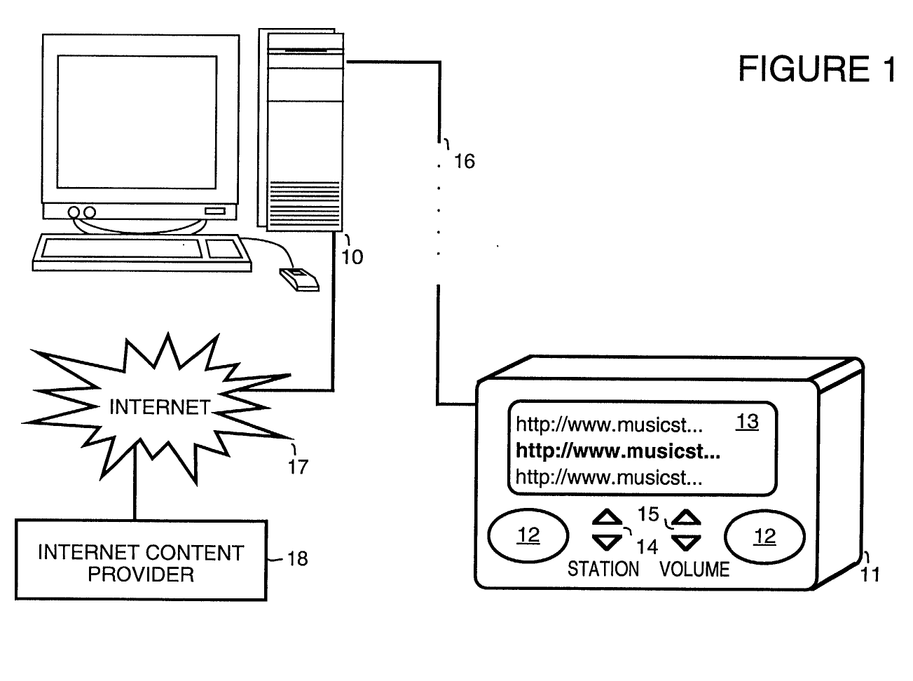

FIG. 1 is a simplified diagram showing a personal computer 10 connected through the internet 17 to an internet content provider 18. For example, internet content provider 18 makes available an audio stream of a radio program. For example, personal computer 10 is connected to internet 17 via a modem, a digital subscriber line (DSL), a cable modem, a wireless internet connection, or by some other of the many ways connection is available to internet 17.

Personal computer 10 is connected to a remote internet radio receiver 11 via a connection 16. Connection 16 is implemented, for example, as a universal serial bus (USB), transmission control protocol/internet protocol (TCP/IP) connection, infrared connection, radio frequency connection, or some other type of connection.

Remote internet radio receiver 11 includes a user interface that includes, for example, speakers 12, a station selection control 14, a volume control 15 and a display 13. Display 13 displays identification of a selected radio station and potential radio stations. For example, display 13 shows internet sites for selected and potential radio station providers. Alternatively, display 13 shows other information that identifies selected and/or potential radio stations available over the internet. In the preferred embodiment, a selected radio station is highlighted for identification.

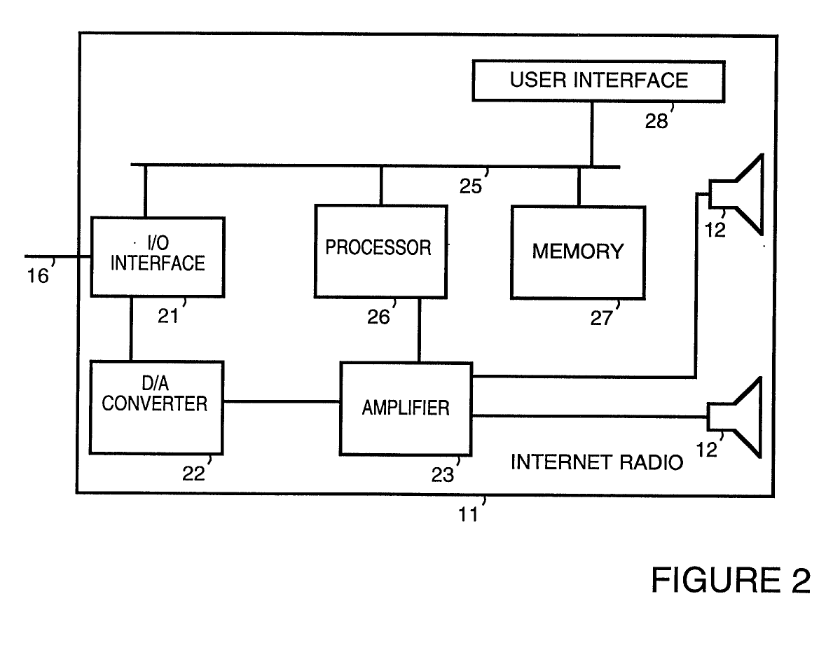

FIG. 2 is a simplified block diagram of remote internet radio receiver 11. An input/output (I/O) interface 21 interfaces with connection 16. Audio stream information from personal computer 10 is directed to digital/analog (D/A) converter 22. The analog information is amplified by an amplifier 23 for play on speakers 12.

Connected to an internal bus 25 are I/O interface 21, a processor 26, a memory 27 and a user interface 28. User interface 28 is used to control station selection control 14, volume control 15 and display 13. Memory 27 includes a display buffer for storing information displayed by display 13 as well as storage of programming code and data for processor 26. Processor 26 oversees operation of remote internet radio receiver 11.

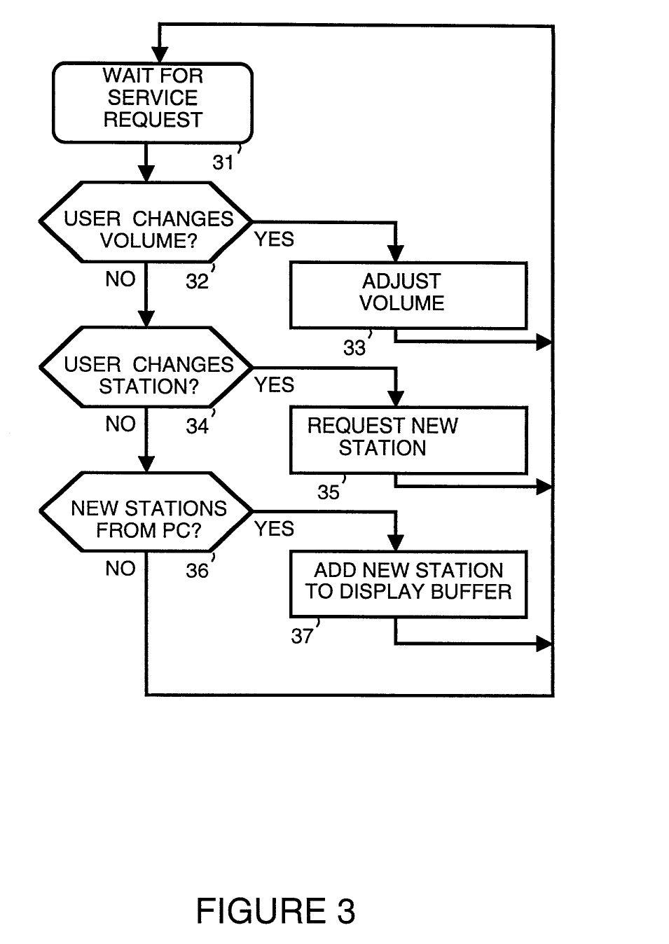

FIG. 3 is a simplified flowchart illustrating operation of processor 26. In a step 31, processor 26 waits for a service request. When a service request is received, processor 26 determines what service is requested.

In a step 32, processor 26 determines whether a user has used volume control to request an increase or a decrease in volume. If so, in a step 33, processor 26 adjusts volume via control signals to amplifier 23.

In a step 34, processor 26 determines whether a user has used station selection control to request a change in radio station. If so, in a step 35, processor 26 sends a control message to personal computer indicating the requested station change. A monitoring program running on personal computer 10 downloads an audio information stream for the selected radio station to remote internet radio receiver 11.

In a step 36, processor 26 determines whether the monitoring program within personal computer 10 is downloading to remote internet radio receiver 11 identification information for an available internet radio station. If so, in a step 37, processor 26 loads the identification information for the available internet radio station into memory 27 to allow display of the available internet radio station on display 13 and to allow selection of the available internet radio station by a user of remote internet radio receiver 11.

When desired, resources within remote internet radio receiver 11 can be enhanced to provide for greater functionality. For example, memory 27 can be expanded and the processing capability of processor 26 can be enhanced to allow a program to be run that initiates a search for new internet radio station or to initiate consultation with a centralized server on internet 17 for station information. This functionality can also be fully implemented on personal computer 10.

To reduce the cost of manufacture, remote internet radio receiver 11 can also be implemented with some reduced capability. For example, display 13 can be eliminated.

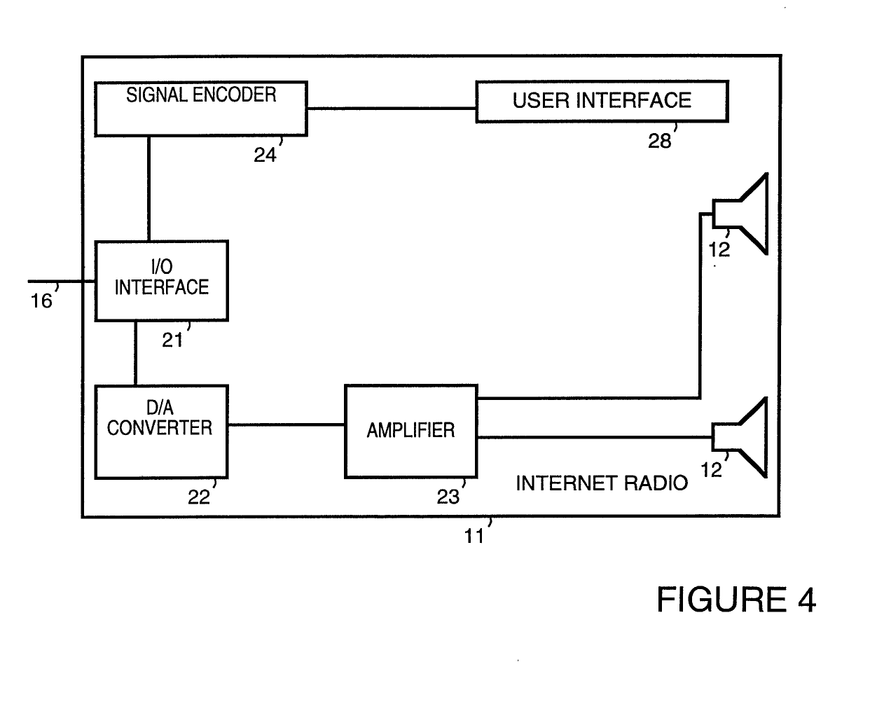

FIG. 4 shows a simplified block diagram of an alternative embodiment of remote internet radio receiver 11 without a display. Input/output (I/O) interface 21 interfaces with connection 16. Audio stream information from personal computer 10 is directed to digital/analog (D/A) converter 22. The analog information is amplified by an amplifier 23 for play on speakers 12.

User interface 28 is used to receive control signals from station selection control 14 and volume control 15. The control signals are encoded by signal encoder 24 and sent by I/O interface 21 to personal computer 10 via connection 16. For station selection requests, the monitoring program running on personal computer 10 downloads an audio information stream for the selected radio station to remote internet radio receiver 11. For volume control requests, the monitoring program running on personal computer 10 adjusts volume information encoded within the audio information stream.

In the preferred embodiments of the present invention, power is delivered to remote internet radio receiver 11 via connection 16 or supplied via a separate power supply (battery power or AC/DC transformer).

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A remote radio receiver comprising:
audio circuitry for receiving a digital audio stream and playing extracted audio signals over a speaker;
a user selection interface;
user control circuitry that generates control signals as a result of a user interacting with the user selection interface; and,
input/output interface for providing connection to a remote computer, wherein the input/output interface forwards the digital audio stream from the remote computer to the audio circuitry, and wherein the input/output interface forwards the control signals from the user control circuitry to the remote computer.

2. A remote radio receiver as in claim 1 wherein the audio circuitry comprises:
a digital to analog converter for receiving the digital audio stream and converting the digital audio stream to an analog audio stream; and,
an amplifier for amplifying the analog audio stream.

3. A remote radio receiver as in claim 1 wherein the user selection interface comprises:
a volume control; and,
a station selection control.

4. A remote radio receiver as in claim 1 additionally comprising:
a display for displaying a selected radio station.

5. A remote radio receiver as in claim 1 wherein the user control circuitry comprises a signal encoder.

6. A remote radio receiver as in claim 1 wherein the user control circuitry comprises a processor and a memory.

7. A remote radio receiver as in claim 1 additionally comprising:
a display for displaying a selected radio station;
wherein the user control circuitry comprises a processor and a memory; and,
wherein identification information for the selected radio station is stored in the memory.

8. A remote radio receiver as in claim 7 wherein identification information for additional radio stations is stored in the memory.

9. A method for providing remote radio reception comprising the following steps performed by a single integrated unit:
(a) receiving a digital audio stream and playing extracted audio signals over a speaker;
(b) generating control signals as a result of a user interacting with a user selection interface; and, (c) providing connection to a remote computer, including the following substeps:
(c.1) receiving the digital audio stream from the remote computer, and
(c.2) forwarding the control signals to the remote computer.

10. A method as in claim 9 wherein step (a) includes the following substeps:
(a.1) receiving the digital audio stream and converting the digital audio stream to an analog audio stream; and,
(a.2) amplifying the analog audio stream.

11. A method as in claim 9 wherein in step (b) the user selection interface includes a volume control and a station selection control.

12. A method as in claim 9 additionally comprising the following step:
(d) displaying a selected radio station.

13. A method as in claim 9 wherein step (b) is performed by a signal encoder.

14. A method as in claim 9 wherein step (b) is performed by a processor with access to a memory.

15. A method as in claim 9 additionally comprising the following steps:
(d) a display for displaying a selected radio station; and,
(e) storing identification information for the selected radio station in a memory.

16. A method as in claim 15 additionally comprising the following step:
(f) storing identification information for additional radio stations in the memory.
